(19) United States
(12) Patent Application Publication
(10) Pub. No.: US 2026/0011924 A1
(43) Pub. Date: Jan. 8, 2026

(54) FEEDHORN

(71) Applicant: INTELLIAN TECHNOLOGIES, INC., Pyeongtaek-si (KR)

(72) Inventors: Woo Chang CHOI, Osan-si (KR); Chang Hyun LEE, Icheon-si (KR)

(21) Appl. No.: 18/881,486

(22) PCT Filed: Jun. 30, 2023
(86) PCT No.: PCT/KR2023/009261

§ 371 Date: Jan. 6, 2025

(30) Foreign Application Priority Data
Oct. 21, 2022 (KR) 10-2022-0136192

(51) Int. Cl. H01Q 13/02; H01Q 5/30

(52) U.S. Cl. CPC H01Q 13/0233; H01Q 5/30

(57) ABSTRACT

Disclosed is a feedhorn. The feedhorn provided in a multi-band antenna using a coaxial waveguide comprises: the coaxial waveguide including a first waveguide that is provided on one side of a reflector and allows a first band signal to pass therethrough and a second waveguide that shares the same axis with the first waveguide, has a larger diameter than the first waveguide, and allows a second band signal to pass therethrough; and a dielectric that is provided between the coaxial waveguide and a sub-reflector on one side of the coaxial waveguide and protrudes radially with respect to the axis of the coaxial waveguide.

### TECHNICAL FIELD

The following embodiments relate to a feedhorn.

### BACKGROUND ART

With a gradual increase in satellite communication services, the need to develop a multiband antenna that outperforms a single-band antenna has increased. However, a waveguide having a coaxial structure is used for a multiband antenna, which bulks up the size of a feedhorn and limits its application to a small-sized antenna, such as a VSAT antenna. In addition, multiband antennas show lower antenna performance, such as antenna gain, axial ratio, or coherence, compared to single-band antennas.

Meanwhile, Korean Patent Publication No. 10-1757681 discloses a satellite communication antenna capable of receiving multiband signals. The antenna disclosed in the present application is configured to transmit and receive different bands by adjusting the orientation of a sub-reflecting board while a plurality of feedhorns is installed fixedly in a main reflecting board.

The above description is information the inventor(s) acquired during the course of conceiving the present disclosure, or already possessed at the time, and was not necessarily publicly known before the present application was filed.

### DISCLOSURE OF THE INVENTION

### Technical Goals

An aspect aims to provide a feedhorn that may transmit and receive multiband signals while satisfying satellite standards and may secure performance higher than that of a single-band antenna.

The technical aspects obtainable from the present disclosure are non-limited by the above-mentioned technical aspects, and other unmentioned technical aspects can be clearly understood from the following description by those having ordinary skill in the technical field to which the present disclosure pertains.

### Technical Solutions

According to an embodiment, a feedhorn is disclosed. The feedhorn provided in a multiband antenna using a coaxial waveguide includes the coaxial waveguide including a first waveguide that is provided on one side of a reflecting board and is configured to pass a first band signal and a second waveguide that shares the same axis as that of the first waveguide, has a diameter greater than that of the first waveguide, and is configured to pass a second band signal and a dielectric that is provided between the coaxial waveguide and a sub-reflecting board that is provided on one side of the coaxial waveguide and radially protrudes based on an axis of the coaxial waveguide.

According to an aspect, a fine protrusion may be formed on a surface of the dielectric.

According to an aspect, a distance to the dielectric from the axis of the coaxial waveguide may change in a direction from the coaxial waveguide to the sub-reflecting board.

According to an aspect, a sub-reflecting board protrusion may be provided on one side of the sub-reflecting board, and the dielectric may be formed to surround the sub-reflecting board protrusion.

According to an aspect, a first air layer may be formed between the dielectric and the sub-reflecting board protrusion.

According to an aspect, a first slot may be formed inside the second waveguide, and the feedhorn may further include a waveguide fixer that is provided in the dielectric, has a shape less than or equivalent to the size of the first slot, and is inserted into the first slot to fix the dielectric.

According to an aspect, the waveguide fixer may protrude in a radius direction of the coaxial waveguide and may include a radius direction protrusion with its end being formed to an outer circumferential surface of the first waveguide.

According to an aspect, a second air layer may be formed between the waveguide fixer and the first waveguide.

According to an aspect, a second band signal suppressor may be formed on an outer circumferential surface of the first waveguide.

According to an aspect, the second band signal suppressor may include a plurality of protruding elements, and the plurality of protruding elements may protrude from the inside of the first waveguide outwardly.

According to an aspect, a second slot may be formed inside the sub-reflecting board.

The feedhorn may further include a sub-reflecting board fixer that is provided in the dielectric, has a shape less than or equivalent to the size of the second slot, and is inserted into the second slot to fix the dielectric.

According to an aspect, a spillover component generated in a fine protrusion of the dielectric and a higher order mode suppressor configured to offset a rise of a cross-polarization level may be provided on the edges of the sub-reflecting board.

### Effects of the Invention

According to embodiments, a feedhorn may transmit and receive multiband signals while satisfying satellite standards and may secure performance higher than that of a single-band antenna.

The effects of the feedhorn, according to an embodiment, are not limited to the foregoing effects, and unstated effects may be clearly understood by those skilled in the art from the description below.

### BRIEF DESCRIPTION OF DRAWINGS

FIG. 1 is a diagram schematically illustrating a configuration of a multiband antenna according to an embodiment.

FIGS. 2A and 2B are diagrams each illustrating a configuration of a feedhorn according to an embodiment.

FIGS. 3A and 3B are diagrams each illustrating a configuration of a second band signal suppressor according to an embodiment.

FIGS. 4A and 4B are diagrams each illustrating a combined shape of a dielectric without a fine protrusion being formed and a sub-reflecting board without a higher mode suppressor being formed and a combined shape of a dielectric with a fine protrusion being formed and a sub-reflecting board with a higher mode suppressor being formed, according to an embodiment.

FIGS. 5A and 5B are graphs each illustrating a radiation pattern of a sub-reflecting board according to the dielectrics without a fine protrusion being formed and with a fine protrusion being formed of FIGS. 4A and 4B.

FIGS. 6A and 6B are graphs each illustrating an amplitude of the sub-reflecting boards without a higher mode suppressor being formed and with a higher mode suppressor being formed of FIGS. 4A and 4B.

FIG. 7 is a diagram illustrating a configuration of an air layer formed between a sub-reflecting board protrusion and a dielectric, according to an embodiment.

FIG. 8 is a diagram illustrating the suppression of a cross-polarization component as the air layer of FIG. 7 is formed.

FIG. 9 is a diagram illustrating a configuration of a waveguide fixer according to an embodiment.

FIGS. 10A to 10D are diagrams each illustrating a pattern of a first band signal and a second band signal of the feedhorn according to an embodiment.

The accompanying drawings illustrate preferred embodiments of the present invention and are provided together with the detailed description for a better understanding of the technical idea of the present invention. Therefore, the present invention should not be construed as being limited to the embodiments set forth in the drawings.

### BEST MODE FOR CARRYING OUT THE INVENTION

Hereinafter, embodiments are described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like constituent elements and a repeated description related thereto will be omitted. In the description of embodiments, detailed description of well-known related structures or functions will be omitted when it is deemed that such description will cause ambiguous interpretation of the present disclosure.

In addition, terms such as first, second, A, B, (a), (b), and the like may be used to describe components of the embodiments. These terms are used only for the purpose of discriminating one component from another component, and the nature, the sequences, or the orders of the components are not limited by the terms. When one component is described as being “connected,” “coupled,” or “attached” to another component, it should be understood that one component may be connected or attached directly to another component, and an intervening component may also be “connected,” “coupled,” or “attached” to the components.

A component, which has the same common function as a component included in any one embodiment, will be described by using the same name in other embodiments. Unless disclosed to the contrary, the configuration disclosed in any one embodiment may be applied to other embodiments, and the specific description of the repeated configuration will be omitted.

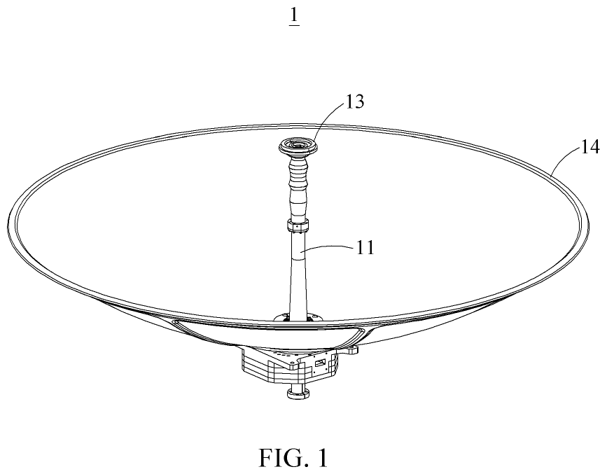

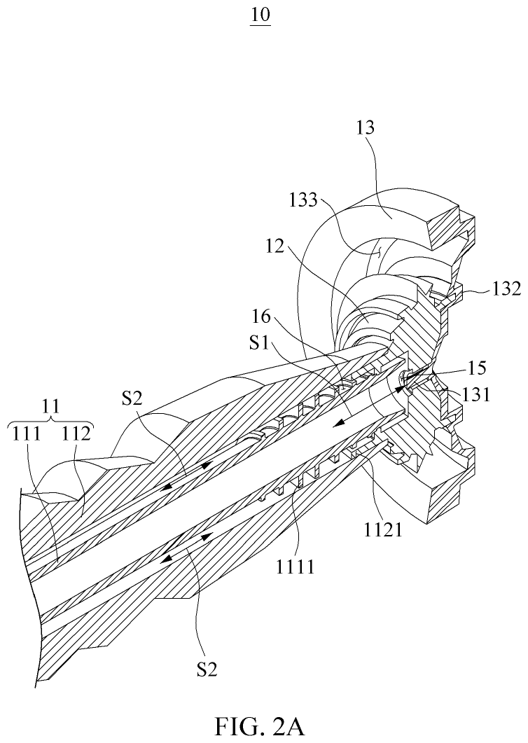

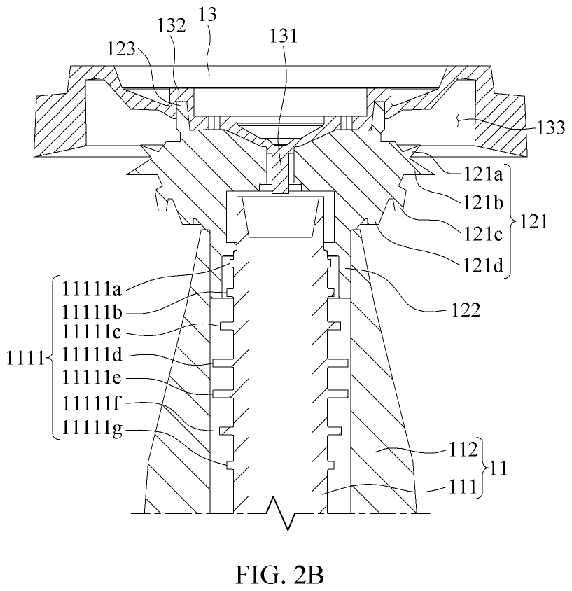

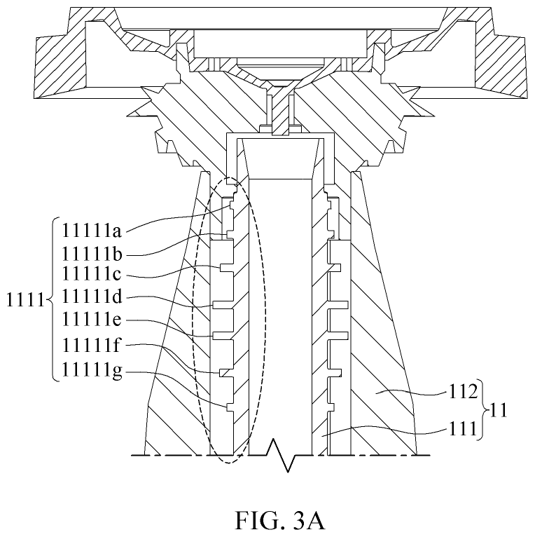

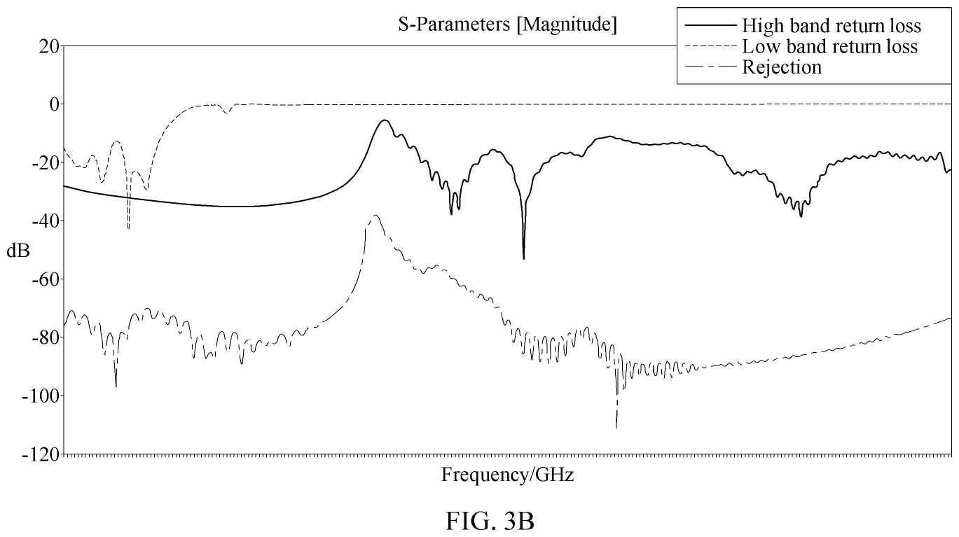

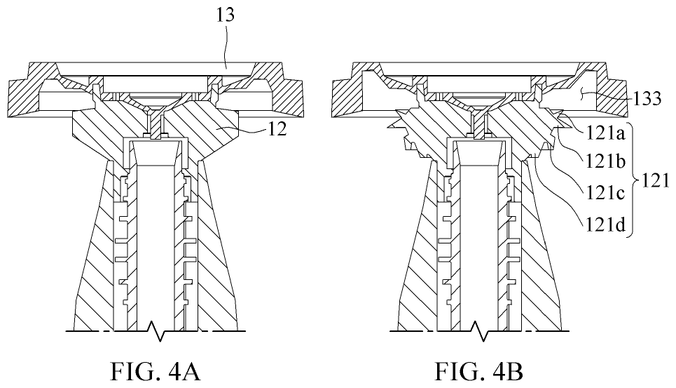

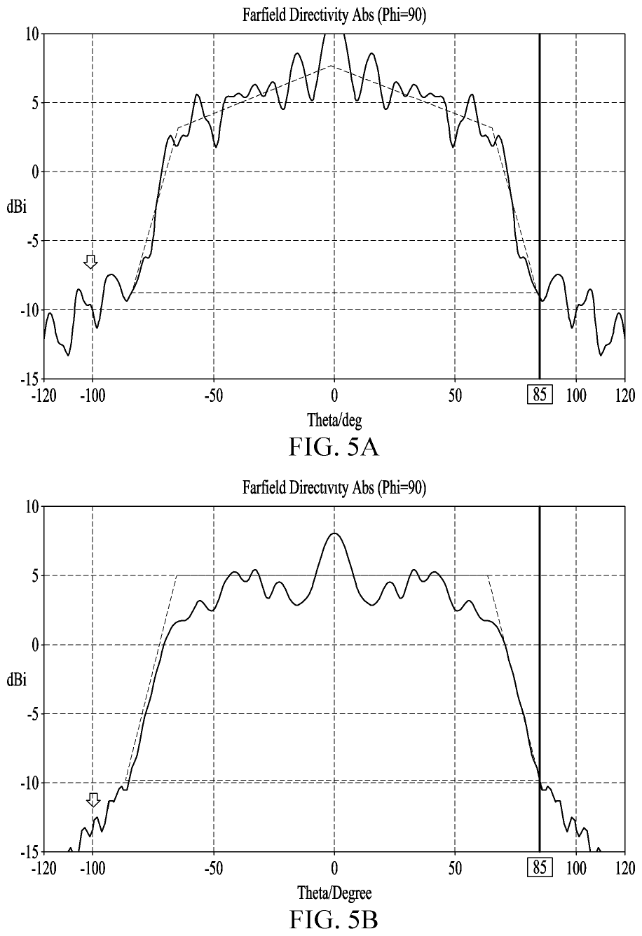

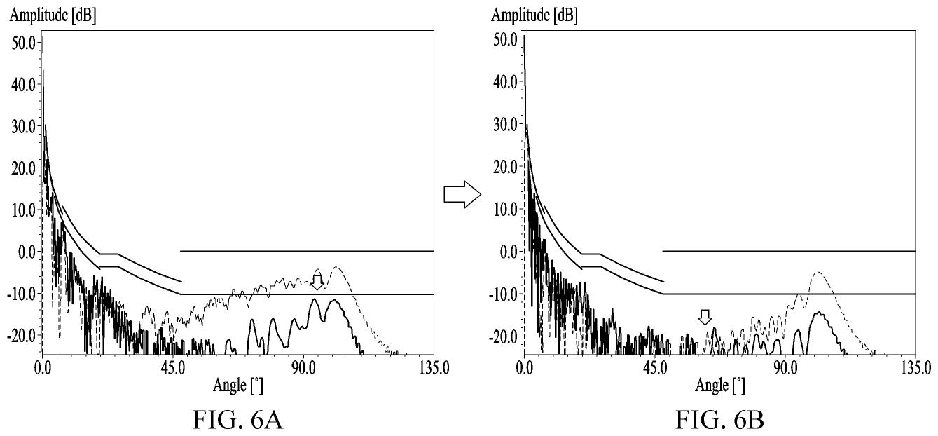

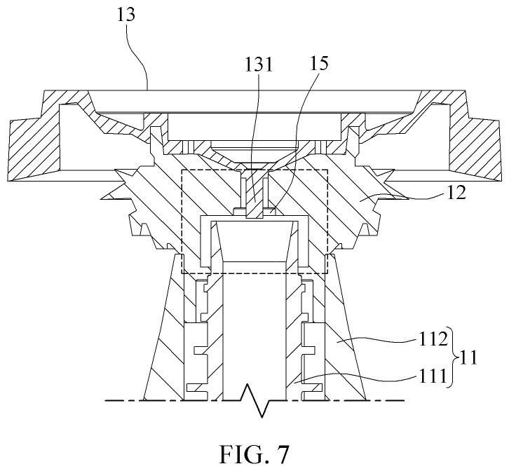

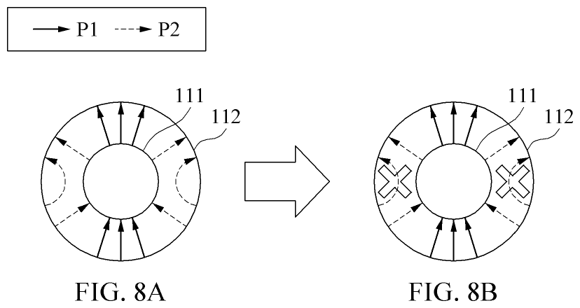

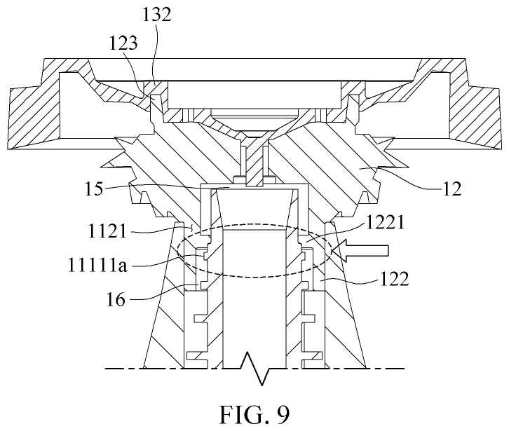

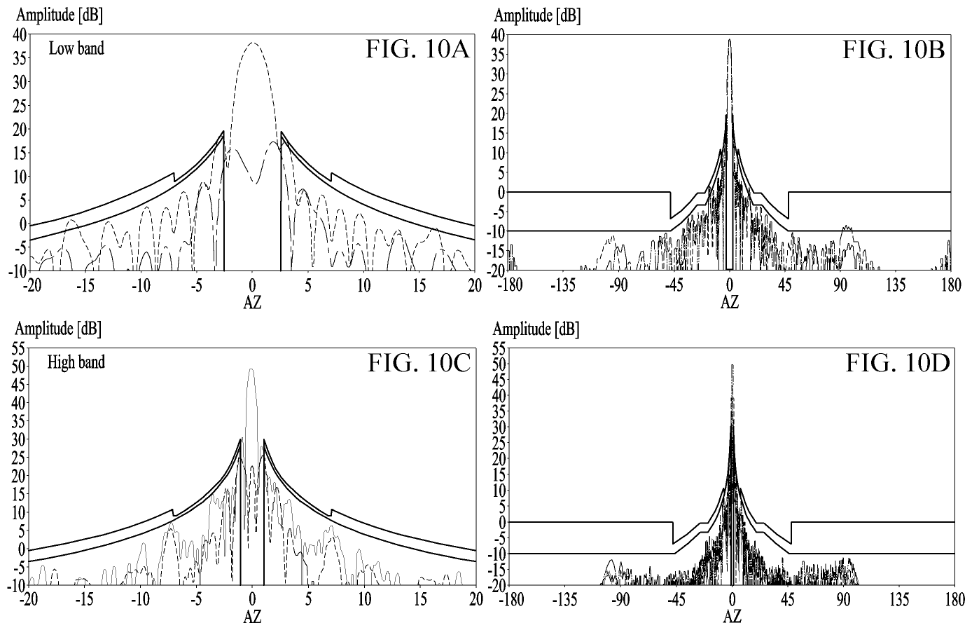

A feedhorn 10 is described with reference to the drawings. FIG. 1 is a diagram schematically illustrating a configuration of a multiband antenna according to an embodiment, FIGS. 2A and 2B are diagrams each illustrating a configuration of a feedhorn according to an embodiment, FIGS. 3A and 3B are diagrams each illustrating a configuration of a second band signal suppressor according to an embodiment, FIGS. 4A and 4B are diagrams each illustrating a combined shape of a dielectric without a fine protrusion being formed and a sub-reflecting board without a higher mode suppressor being formed and a combined shape of a dielectric with a fine protrusion being formed and a sub-reflecting board with a higher mode suppressor being formed, according to an embodiment, FIGS. 5A and 5B are graphs each illustrating a radiation pattern of a sub-reflecting board according to the dielectrics without a fine protrusion being formed and with a fine protrusion being formed of FIGS. 4A and 4B, FIGS. 6A and 6B are graphs each illustrating an amplitude of the sub-reflecting boards without a higher mode suppressor being formed and with a higher mode suppressor being formed of FIGS. 4A and 4B, FIG. 7 is a diagram illustrating a configuration of an air layer formed between a sub-reflecting board protrusion and a dielectric, according to an embodiment, FIG. 8 is a diagram illustrating the suppression of a cross-polarization component as the air layer of FIG. 7 is formed, FIG. 9 is a diagram illustrating a configuration of a waveguide fixer according to an embodiment, and FIGS. 10A to 10D are diagrams each illustrating a pattern of a first band signal and a second band signal of the feedhorn according to an embodiment.

Referring to FIGS. 1, 2A, and 2B, in a multiband antenna 1 using a coaxial waveguide 11, a feedhorn 10 is configured by including the coaxial waveguide 11 and a dielectric 12.

Referring to FIGS. 2A and 2B, the coaxial waveguide 11, according to an embodiment, may include a first waveguide 111 and a second waveguide 112.

According to an embodiment, the first waveguide 111 may be provided on one side of a reflecting board 14 and may pass a first band signal S1 in an electromagnetic wave form. In addition, the first band signal S1 may be the Ka-band frequency having a band from 26.5 GHz to 40 GHz, but examples are not limited thereto.

According to an embodiment, the second waveguide 112 shares the same axis as that of the first waveguide 111, has a diameter greater than that of the first waveguide 111, and passes a second band signal S2. In addition, the second band signal S2 may be the X-band frequency having a band from 8 GHz to 12 GHz, but examples are not limited thereto. A frequency having a band relatively lower than the first band signal S1 may be applied.

According to an embodiment, the second waveguide 112 may include a first slot 1121 formed inside the second waveguide 112. A waveguide fixer 122 of the dielectric 12 to be described below may be inserted into the first slot 1121. The first slot 1121 may be formed inside an axial direction of the second waveguide 112 to fix the dielectric 12 to the second waveguide 112. The shape of the first slot 1121 is not limited to the drawings and may be flexibly changed.

According to an embodiment, a second band signal S2 suppressor 1111 may be formed on an outer circumferential surface of the first waveguide 111.

According to an embodiment, the second band signal S2 suppressor 1111 may include a plurality of protruding elements 11111, and the plurality of protruding elements 11111 may protrude from the inside of the first waveguide 111 outwardly. In this case, the height (or diameter) of protrusion of the plurality of protruding elements 11111 may be different and may vary depending on the purpose of the design. In addition, the number of protruding elements 11111 is not limited and may be changed, and the length, thickness, or shape may also vary depending on designs. By this configuration, the first band signal S1 may be passed by the first waveguide 111, the second band signal S2 may be blocked, and other unnecessary signals may be suppressed.

Referring to FIG. 3B, it is desirable to configure the second band signal S2 suppressor 1111, as illustrated in FIG. 3A, including seven protruding elements 11111. The second band signal S2 suppressor 1111, when configured by including seven protruding elements 11111, may attenuate −50 db or more. By this configuration, it may be confirmed that a reflection loss or an insertion loss of the second band signal S2 is minimized as an influx of the first band signal S1 into the second waveguide 112 is suppressed.

Referring to FIG. 4A, according to an embodiment, the dielectric 12 may be provided between the coaxial waveguide 11 and a sub-reflecting board 13 provided on one side of the coaxial waveguide 11 and may radially protrude based on the axis of the coaxial waveguide 11. In this case, a distance to the dielectric 12 from the axis of the coaxial waveguide 11 may change in a direction from the coaxial waveguide 11 to the sub-reflecting board 13.

In addition, according to an embodiment, a fine protrusion 121 may be formed on a surface of the radially protruding dielectric 12. Referring to FIG. 4B, the dielectric 12, by having the radially protruding shape based on the axis of the coaxial waveguide 11, may transmit an electromagnetic wave relayed through the coaxial waveguide 11 in a certain direction toward the sub-reflecting board 13 or may receive an electromagnetic wave introduced in a certain direction through the sub-reflecting board 13. As the fine protrusion 121 is formed on the surface of the radially protruding dielectric 12, a higher mode component may be suppressed through basic mode pattern radiation. The direction and position of the fine protrusion 121 may be changed by determining a direction requiring the suppression or additional radiation of a signal after confirming a signal level of an antenna pattern in each direction. By this configuration, the fine protrusion 121 has a suppressing or offsetting effect on a higher order component and thus may perform similarly to a single-band antenna.

In addition, according to an embodiment, the sub-reflecting board 13 may include a spillover component generated in the fine protrusion 121 of the dielectric 12 and a higher order mode suppressor 133 that offsets a rise of a cross-polarization level. To fine-tune a spillover component, the shape and depth of the higher order suppressor 133 may be changed flexibly. When the fine protrusion 121 is formed on the surface of the dielectric 12, as a phase value and a direction of an antenna pattern change, a spillover component and a cross-polarization level may rise. By including the higher order mode suppressor 133 on the edges of the sub-reflecting board 13, a rise may be offset to be tuned to a certain value or less.

Referring to FIG. 5A, it may be confirmed that a radiation pattern of the sub-reflecting board 13 to which the dielectric 12 without the fine protrusion 121 being formed is applied exceeds 10 db in a 0-degree area, and a spillover phenomenon occurs due to a higher mode component in an area of −85 degrees or less and 85 degrees or more. In comparison, referring to FIG. 5B, it may be confirmed that the spillover phenomenon may be minimized by suppressing a higher mode component when applying the dielectric 12 with the fine protrusion 121 being formed.

FIGS. 6A and 6B are graphs each illustrating an amplitude of the sub-reflecting board 13 without the higher mode suppressor 133 being formed and the sub-reflecting board 13 with the higher mode suppressor 133 being formed that are illustrated in FIGS. 4A and 4B. Comparing FIG. 6A with FIG. 6B, it may be confirmed that the forming of the higher mode suppressor 133 on the sub-reflecting board 13 may produce an effect of offsetting a rise of a spillover component and a cross-polarization level.

Referring to FIG. 7, according to an embodiment, the sub-reflecting board 13 may include a sub-reflecting board protrusion 131 formed as a conductor on its one side. When the sub-reflecting board protrusion 131 is provided on the reflecting board 14, the dielectric 12, according to an embodiment, may be formed to surround the sub-reflecting board protrusion 131.

In this case, according to an embodiment, a first air layer 15 may be formed between the dielectric 12 and the sub-reflecting board protrusion 131. It is required to excite a basic mode of the first waveguide 111 and the second waveguide 112 around the sub-reflecting board protrusion 131 and suppress a higher order mode. For example, the basic mode may be a TE11 mode that is excited in a ty direction as illustrated in FIG. 8.

In addition, when excited to the TE11 mode, the dielectric 12 with the first air layer 15 being formed may radiate only a co-polarization component P1 of which an electric field is formed in a straight line and may suppress an exterior angle cross-polarization component P2 of which an electric filed is formed in a curved line. The first air layer 15 may mitigate a rotation component that may be generated by a large difference between the dielectric rates of the coaxial waveguide 11 configured with a conductor and the dielectric 12 to suppress the exterior angle cross-polarization component P2. In other words, when an electromagnetic wave having been inside the coaxial waveguide 11 is directly incident on the dielectric 12, the electromagnetic wave rotates due to a sudden change of a dielectric rate between media, and an unnecessary pattern component or the exterior angle cross-polarization component P2 may be generated. If the exterior angle cross-polarization component P2 is generated, the bandwidth of an electromagnetic wave is narrower. Thus, a wide-band electromagnetic wave feature to be obtained by using the coaxial waveguide 11 may not be secured.

In the case of the dielectric 12 with the first air layer 15 being formed, an electromagnetic wave is incident on a surface including an end of the coaxial waveguide 11 configured with a conductor, the dielectric 12, and the first air layer 15 together, and thus, the first air layer 15 may suppress the rotation of the electromagnetic wave and the exterior angle cross-polarization component P2. In other words, the dielectric 12 with the first air layer 15 being formed may secure a wide-band feature of an electromagnetic wave by suppressing the exterior angle cross-polarization component P2.

In addition, according to an embodiment, it is desirable that the width of the first air layer 15 is formed less than or equal to λ/8, and the length of the first air layer 15 is formed less than or equal to λ/2.

Referring to FIG. 9, according to an embodiment, the dielectric 12 may include the waveguide fixer 122 that has a shape less than or equivalent to the size of a first slot 1121 and is inserted into the first slot 1121 to fix the dielectric 12. The waveguide fixer 122 may be formed to protrude such that the dielectric 12 is inserted between an outer diameter of the first waveguide 111 and an inner diameter of the second waveguide 112 to be fixed. In this case, one surface of a waveguide fixer may face the inner diameter of the second waveguide 112 and the other surface thereof may face the first air layer 15.

According to an embodiment, the waveguide fixer 122 may protrude in a radius direction of the coaxial waveguide 11 and may include a radius direction protrusion 1221 with its end being formed to an outer circumferential surface of the first waveguide 111. An end of the radius direction protrusion 1221 may face the outer diameter of the first waveguide 111 such that the waveguide fixer 122 may not shake in a radius direction of the coaxial waveguide 11. In this case, it is desirable to apply a length that is less than or equal to λ/10 of the second band signal S2 to the width of the radius direction protrusion 1221 to minimize a signal impact.

In addition, a groove that accommodates the protruding elements 11111 may be formed at an end of the radius direction protrusion 1221 to face the protruding elements 11111 of the second band signal S2 suppressor 1111. If the radius direction protrusion 1221 and the protruding elements 11111 of the second band signal S2 suppressor 1111 are separately provided, a shift phenomenon of a suppression band and a passing band may occur. Thus, it is desirable to configure that the radius direction protrusion 1221 faces the protruding elements 11111.

According to an embodiment, a second air layer 16 may be formed between the waveguide fixer 122 and the first waveguide 111. If the radius direction protrusion 1221 is provided in the waveguide fixer 122, the first air layer 15 is formed in a direction where the sub-reflecting board 13 is positioned based on the radius direction protrusion 1221, and the second air layer 16 diverges in a direction where the reflecting board 14 is positioned. In this case, it is desirable that the width of the second air layer 16 should also be formed as λ/8 of the first band signal S1, the same as the width of the first air layer 15.

In addition, a second slot 132 formed inside the sub-reflecting board 13, and the sub-reflecting board fixer 123 that is provided in the dielectric 12, has a shape less than or equivalent to the size of the second slot 132, and is inserted into the second slot 132 to fix the dielectric 12 are included. The second slot 132 and the sub-reflecting fixer 123 may connectively fix the dielectric 12 and the sub-reflecting board 13 and may stably support the dielectric 12.

A radiation pattern of an antenna including the feedhorn 10 formed as described above is described through a graph using the Cartesian coordinate system of FIGS. 10A to 10D. FIG. 10A is a graph illustrating a radiation pattern with a low band, that is, at a narrow angle (±20 degrees) of the second band signal S2, FIG. 10B is a graph illustrating a radiation pattern in all directions (±180 degrees) of the second band signal S2, FIG. 10C is a graph illustrating a radiation pattern with a high band, that is, at a narrow angle (±20 degrees) of the first band signal S1, and FIG. 10D is a graph illustrating a radiation pattern in all directions (±180 degrees) of the first band signal S1. Referring to FIG. 10A, it may be confirmed that a green co-polarization pattern and a yellow cross-polarization pattern at a narrow angle (±20 degrees) of the second band signal S2 are positioned in a black Wideband Global SATCOM (WGS) certification mask condition. Referring to FIG. 10B, it may be confirmed that a purple co-polarization pattern and a green cross-polarization pattern in all directions (±180 degrees) are also positioned in the black WGS certification mask condition. For reference, a WGS certification mask is divided into a WGS mask positioned below and a WGS relaxation mask positioned above. It is stipulated that requirements are satisfied when a value exceeding a WGS mask range is less than or equal to 10% if not exceeding a WGS relaxation mask range even if exceeding the WGS mask range.

Likewise, referring to FIG. 10C, it may be confirmed that a purple co-polarization pattern and a red-purple cross-polarization pattern at a narrow angle (±20 degrees) of the first band signal S1 are positioned in the black WGS certification mask condition. Referring to FIG. 10D, it may be confirmed that a purple co-polarization pattern and a green cross-polarization pattern in all directions (±180 degrees) are positioned in the black WGS certification mask condition. As such, according to an embodiment, while the feedhorn 10 uses the coaxial waveguide 11 that simultaneously transmits and receives the first band signal S1 and the second band signal S2, it may be confirmed that both the radiation patterns of the first band signal S1 and the second band signal S2 may be used in the WGS certification.

According to embodiments, the feedhorn 10 may secure performance similar to that of a single-band antenna by suppressing a higher order mode through the sub-reflecting board 13 including the higher order mode suppressor 133 and the dielectric 12 with the fine protrusion 121 being formed.

In addition, the feedhorn 10 may stably couple the dielectric 12 between a waveguide and the sub-reflecting board 13 through the configuration of the waveguide fixer 122 and the sub-reflecting board fixer 123.

In addition, the feedhorn 10 may maintain basic mode performance by forming an air layer and may suppress a higher order mode while minimizing a reflection loss.

In addition, the feedhorn 10 may suppress unnecessary signals in the coaxial waveguide 11 through the configuration of the second band signal S2 suppressor 1111.

A number of embodiments have been described above. Nevertheless, it should be understood that various modifications may be made to these embodiments. Suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

1. A feedhorn comprised in a multiband antenna using a coaxial waveguide, the feedhorn comprising:
the coaxial waveguide comprising a first waveguide that is comprised on one side of a reflecting board and is configured to pass a first band signal and a second waveguide that shares the same axis as that of the first waveguide, has a diameter greater than that of the first waveguide, and is configured to pass a second band signal; and
a dielectric that is comprised between the coaxial waveguide and a sub-reflecting board that is comprised on one side of the coaxial waveguide and radially protrudes based on an axis of the coaxial waveguide.

2. The feedhorn of claim 1, wherein
a fine protrusion is formed on a surface of the dielectric.

3. The feedhorn of claim 1, wherein
a distance to the dielectric from the axis of the coaxial waveguide changes in a direction from the coaxial waveguide to the sub-reflecting board.

4. The feedhorn of claim 1, wherein
a sub-reflecting board protrusion is comprised on one side of the sub-reflecting board, and the dielectric is formed to surround the sub-reflecting board protrusion.

5. The feedhorn of claim 4, wherein
a first air layer is formed between the dielectric and the sub-reflecting board protrusion.

6. The feedhorn of claim 1, wherein
a first slot is formed inside the second waveguide, and
the feedhorn further comprises a waveguide fixer that is comprised in the dielectric, has a shape less than or equivalent to the size of the first slot, and is inserted into the first slot to fix the dielectric.

7. The feedhorn of claim 6, wherein
the waveguide fixer protrudes in a radius direction of the coaxial waveguide and comprises a radius direction protrusion with its end being formed to an outer circumferential surface of the first waveguide.

8. The feedhorn of claim 6, wherein
a second air layer is formed between the waveguide fixer and the first waveguide.

9. The feedhorn of claim 1, wherein
a second band signal suppressor is formed on an outer circumferential surface of the first waveguide.

10. The feedhorn of claim 9, wherein
the second band signal suppressor comprises a plurality of protruding elements, and
the plurality of protruding elements protrudes from the inside of the first waveguide outwardly.

11. The feedhorn of claim 1, wherein
a second slot is formed inside the sub-reflecting board, and
the feedhorn further comprises a sub-reflecting board fixer that is comprised in the dielectric, has a shape less than or equivalent to the size of the second slot, and is inserted into the second slot to fix the dielectric.

12. The feedhorn of claim 1, wherein
a spillover component generated in a fine protrusion of the dielectric and a higher order mode suppressor configured to offset a rise of a cross-polarization level are comprised on the edges of the sub-reflecting board.
